(19) United States
(12) Patent Application Publication
(10) Pub. No.: US 2016/0162893 A1
(43) Pub. Date: Jun. 9, 2016

(54) OPEN, ON-DEVICE CARDHOLDER VERIFICATION METHOD FOR MOBILE DEVICES

(71) Applicant: MasterCard International Incorporated, Purchase, NY (US)

(72) Inventors: Ashfaq Kamal, White Plains, NY (US); Mark Klausen, O'Fallon, MO (US)

(21) Appl. No.: 14/561,575

(22) Filed: Dec. 5, 2014

(51) Int. Cl. G06Q 20/40; G06Q 20/32; G06Q 20/34

(52) U.S. Cl. CPC G06Q 20/405; G06Q 20/34; G06Q 20/3226

(57) ABSTRACT

An open, on-device Cardholder Verification Method (“CVM”) controller may receive CVM policies from issuers and store the policies in a database. The open, on-device CVM controller may then receive a request from a remote mobile device, and automatically determine at least one issuer associated with the request. Appropriate CVM policies may be retrieved and transmitted to the remote mobile device. An open, on-device CVM application executing on the mobile device may then receive a CVM authentication request, associated with a payment token, from a payment application. Responsive to the authentication request, a CVM policy may be accessed based on the payment token. It may then be arranged for an authenticator of the mobile device to authenticate a user in accordance with the CVM policy. When the user is authenticated, an authentication success indication may be sent from the open, on-device CVM application to the payment application.

### BACKGROUND

A user may present a payment token to a merchant in connection with a transaction. For example, a user may present a smartphone to a merchant device in order to provide payment for goods or services via his or her credit or debit card account. To make transactions more secure, a Cardholder Verification Method (“CVM”) may verify that the person using the payment token is actually the authorized cardholder. For example, a user may be asked to provide his or her home ZIP code, a password, or a Personal Identification Number (“PIN”) to help make sure that he or she is actually the authorized cardholder (as opposed to someone who simply found the smartphone).

Note that a mobile device may have a number of different types of built-in authenticators. For example, a mobile device might have a fingerprint scanner, a camera and facial recognition software, etc. to prevent unauthorized users from accessing data on the mobile device. Further note that different issuers of payment tokens may have different rules regarding how CVM should be used to reduce unauthorized transactions. There is not, however, a way in which issuers can define how various built-in mobile device authenticators may be used in connection with payment transactions. As a result, systems and methods to improve payment token transaction security for mobile devices may be desired.

### BRIEF DESCRIPTION OF THE DRAWINGS

FIG. 1 is a block diagram overview of a system according to some embodiments.

FIG. 2 illustrates an open, on-device CVM controller method that might be performed in accordance with some embodiments.

FIG. 3 illustrates an open, on-device CVM application method that might be performed at a mobile device in accordance with some embodiments.

FIG. 4 is a diagram of a system according to some embodiments of the present invention.

FIG. 5 is a process flow diagram illustrating an open, on-device CVM setup procedure in accordance with some embodiments.

FIG. 6 is block diagram of an open, on-device controller tool or platform according to some embodiments of the present invention.

FIG. 7 is a tabular portion of a CVM policy database according to some embodiments.

FIG. 8 is a process flow diagram illustrating an open, on-device CVM payment procedure in accordance with some embodiments.

FIG. 9 is a block diagram overview of mobile device in accordance with some embodiments.

FIG. 10 illustrates an open, on-device CVM environment in accordance with some embodiments.

FIG. 11 is an example of a mobile device display that might be provided in accordance with some embodiments.

### DETAILED DESCRIPTION

A user may present a payment token to a merchant in connection with a transaction. For example, a user may present a smartphone to a merchant device in order to provide payment for goods or services via his or her credit or debit card account. To make transactions more secure, a CVM may verify that the person using the payment token is actually the authorized cardholder. Note that a mobile device may have a number of different types of built-in “authenticators.” As used herein, the term “authenticator” may refer to any hardware, software, or combination of hardware and software that can authentic a user of a mobile device, including devices associated with a biometric authenticator, voice recognition, a fingerprint scanner, a camera and facial recognition software, etc. Further note that different issuers of payment tokens may have different rules regarding how CVM should be used to reduce unauthorized transactions.

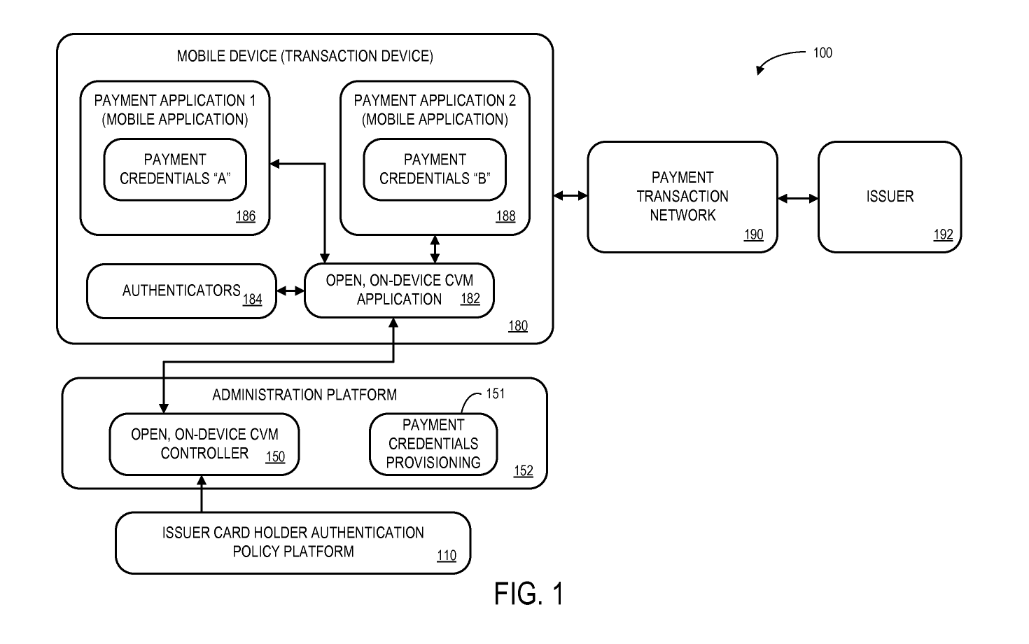

FIG. 1 is a diagram of a system 100 according to some embodiments of the present invention. In particular, the system 100 may include an open, on-device CVM controller 150 that receives CVM policies from an issuer card holder authentication policy platform 110. According to some embodiments, the on-device CVM controller 150 is part of an administration platform 152 which might also handle payment credentials provisioning 154 and other administrative tasks. The open, on-device CVM controller 150 may provide the appropriate CVM policies to an open, on-device CVM application 182 executing at a mobile device 180. The open, on-device CVM application 182 may exchange trusted information with one or more authenticators 184 and payment applications 186, 188 (e.g., which each might be associated with different payment credentials, such as credit card numbers) executing at the mobile device 180. The payment applications 186, 188 may, for example, provide a User Experience (“UX”) to arrange for transactions via a payment transaction network 190 and/or issuer platforms 192.

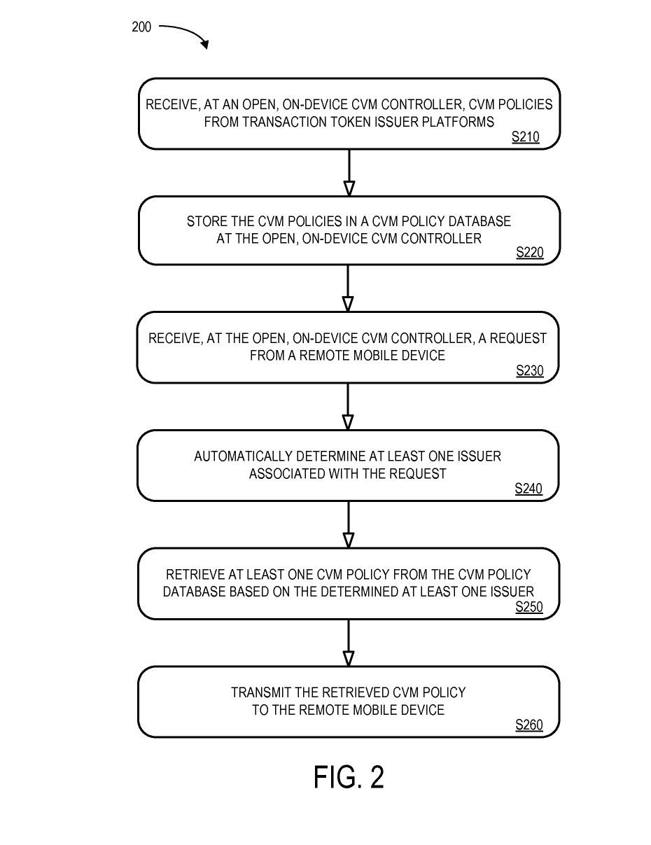

FIG. 2 illustrates a method that might be performed by the open, on-device CVM controller 150 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, an open, on-device CVM controller may receive CVM policies from issuer platforms. At S220, the open, on-device CVM controller may store the CVM policies in a CVM policy database at the open, on-device CVM controller. A CVM policy might be associated with, for example, a mobile device type, a mobile device authenticator type, a PIN, and/or a transaction amount. According to some embodiments, a CVM policy may be received from an issuer at the time of digitizing a Primary Account Number (“PAN”) onto a device.

The open, on-device CVM controller may then receive a request from a remote mobile device at S230, and automatically determine at least one issuer associated with the request S240. The request might be associated with, for example, a registration request for a “payment token” being added to a payment application on the mobile device. The payment token might be associated with, for example, a credit card, a debit card, or a pre-paid stored value card. At least one CVM policy may be retrieved from the CVM policy database at S250 based on the determined at least one issuer, and the retrieved CVM policy may be transmitted to the remote mobile device at S260. According to some embodiments, the open, on-device CVM controller may also transmit a CVM policy update to the remote mobile device (e.g., either on a periodic basis or when there is a change to a CVM policy).

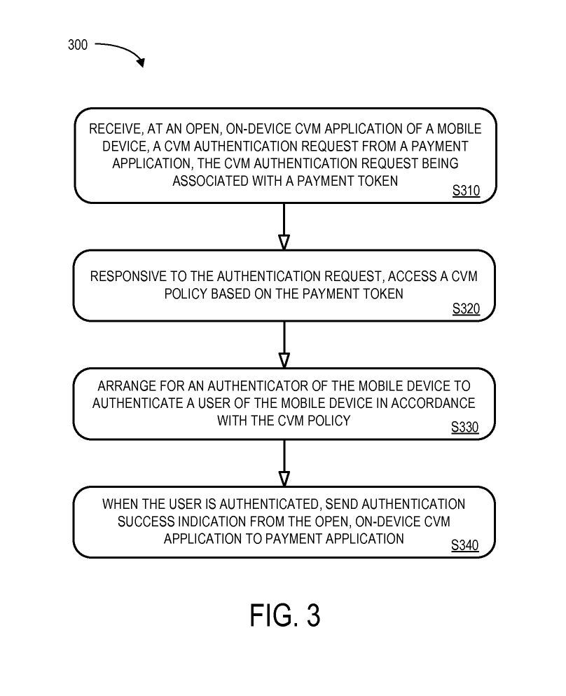

The CVM policies delivered by the open, on-device CVM controller may then be used to facilitate purchases made using “mobile devices” and associated authenticators. For example, FIG. 3 illustrates an open, on-device CVM application method that might be performed at a “mobile device” in accordance with some embodiments. As used herein, the phrase “mobile device” might refer to, for example, a smartphone, a tablet computer, a watch, an automobile, a laptop computer, and/or pair of eyeglasses.

At S310, an open, on-device CVM application executing in a “secure execution environment” of a mobile device may receive a CVM authentication request from a payment application executing in an application execution environment of the mobile device. Moreover, the CVM authentication request may be associated with a payment token (e.g., a credit or debit card account or a pre-paid stored value card). As used herein, the phrase “secure execution environment” may refer to, for example, a secure area of a processor of a smartphone (or another connected device including tablets, watches, etc.). The secure execution environment may help ensure that code and data loaded inside the environment is protected with respect to confidentiality and integrity. The secure execution environment may provide security features such as isolated execution, integrity of trusted applications, and asset confidentiality. Note that secure execution environment may offer an execution space that provides a higher level of security as compared to a rich mobile Operating System (“OS”) or application execution environment. The secure execution environment may run in parallel with the mobile OS, and trusted applications running in the secure execution environment may have access to mobile device's main processor and memory. One example of a secure execution environment is a Trusted Execution Environment (“TEE”).

Responsive to the authentication request, a CVM policy (e.g., a policy associated with a mobile device type, a mobile device authenticator type, PIN, a transaction amount, etc.) may be accessed at S320 based on the payment token, and it may be arranged at S330 for an authenticator of the mobile device to authenticate a user of the mobile device in accordance with the CVM policy. When the user is authenticated, an authentication success indication may be sent from from the open, on-device CVM application to the payment application. For example, the user might want to make a $50.00 purchase using a credit card account. The open, on-device CVM application may receive an authentication request, including the credit card number, and select the appropriate CVM policy which might, for example, indicate that all purchases over $40.00 require fingerprint verification. The on-device CVM application may communication with a fingerprint scanner of the mobile device to arrange for such verification (and inform the payment application of the success or failure of the authentication).

In this way, transactions may be verified as desired by individual issuers. As used herein in, the term “issuer” may include, for example, a financial institution (i.e., bank) issuing a card, a merchant issuing a merchant specific card, a stand-in processor configured to act on-behalf of the card-issuer, or any other suitable institution configured to issue a payment identifier. Moreover, the term “transaction” can be associated with, for example, a merchant, a merchant terminal, an Automated Teller Machine (“ATM”), or any other suitable institution or device configured to initiate or process a financial transaction per the request of the account owner.

The open, on-device CVM application and/or payment application may be associated with, for example, a “payment card processing system” or “credit card processing networks,” such as the MasterCard® network that allows account owners to use payment accounts issued by a variety of issuers to shop at a variety of merchants. With this type of payment account, a card issuer, such as a bank, extends credit to an account owner to purchase products or services. When an account owner makes a purchase from an approved merchant or withdraws funds via an ATM, the card number and amount of the purchase, along with other relevant information, are transmitted via the processing network to a processing center, which verifies that the card has not been reported lost or stolen and that the card's credit limit has not been exceeded. In some cases, the account owner's signature is also verified, a personal identification number is required or other user authentication mechanisms are imposed. The account owner is required to repay the bank for the purchases or cash withdrawals, generally on a monthly basis.

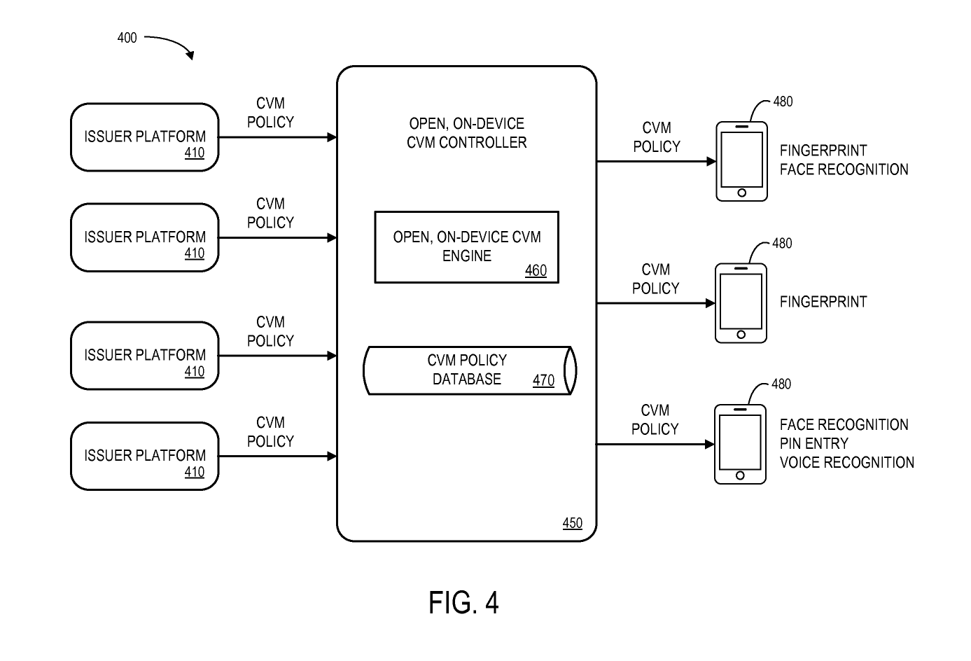

FIG. 4 is a block diagram overview of a system 400 in accordance with some embodiments. As before, an open, on-device CVM controller 450 may receive information from issuer platforms 410 (each associated with an issuer of payment tokens) and exchange information with mobiles devices 480. According to some embodiments, the open, on-device CVM controller 450 exchanges information with remote issuer platforms 410 and/or remote mobile devices 480 via a communication network, such as the Internet and/or a wireless telephone network. According to some embodiments, an “automated” open, on-device CVM controller 450 may facilitate secure transactions. As used herein, the term “automated” may refer to, for example, actions that can be performed with little (or no) intervention by a human.

As used herein, devices, including those associated with the open, on-device CVM controller 450 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks. Although a single open, on-device CVM controller 450 is shown in FIG. 4, any number of such devices may be included. Moreover, various devices described herein might be combined according to embodiments of the present invention.

According to some embodiments, the open, on-device CVM controller 450 may include an open, on-device CVM controller engine 460 that receives CVM policies from issuer platforms 410 and stores the policies in a CVM policy database 470. The CVM policies may be associated with, for example, various types of authenticators associated with the mobile devices 480. For example, one issuer might have a CVM policy indicating that fingerprint authentication is required for all transaction amounts above $40.00, while another issuer has a CVM policy indicating that either face or voice recognition can be used for all transaction amounts above $25.00.

The open, on-device CVM controller 450 may transmit the CVM policy information to the mobile devices 480. According to some embodiments, the open, on-device CVM controller 450 receives a registration request from a mobile device 480 and, responsive to that request, transmits one or more CVM policies to the mobile device 480. The open, on-device CVM controller 450 may also be responsible for providing updates to the mobile devices (e.g., when an issuer changes a CVM policy, a new issuer joins the program, etc.).

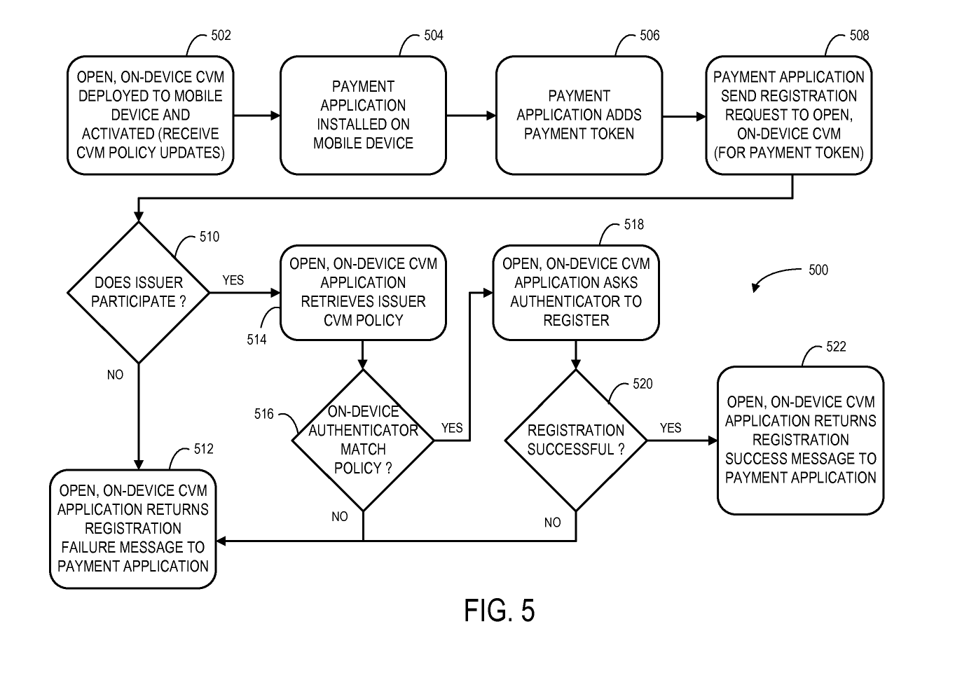

FIG. 5 is a process flow diagram illustrating an open, on-device CVM setup procedure 500 in accordance with some embodiments. Initially, an open, on-device CVM application may be deployed on a mobile device, such as by the Original Equipment Manufacturer (“OEM”), and may be activated by a user at 502. Note that appropriate CVM policies may be received by the device from the OEM and/or an open, on-device CVM controller (when the user activates the application). A payment application, such as an electronic wallet, may be installed on the mobile device at 504, and a payment token (e.g., associated with a credit card account) may be added at 506. When the payment token is added, the payment application transmits a registration request to the open, on-device CVM application at 508.

The open, on-device CVM application may initially determine if the issuer of that payment token being added participates in the open, on-device CVM ecosystem at 510. If the issuer does not participate at 510, the open, on-device CVM application returns a “Registration Failure” message to the payment application at 512 and the process 500 ends. If the issuer does participate at 510, the open, on-device CVM application may retrieve the appropriate CVM policy at 514 and determine if the set of built-in, on-device authenticators match the policy at 516. For example, if the CVM policy indicated that all transactions for a particular issuer require fingerprint verification, and it is determined at 516 that the mobile device does not have a fingerprint scanner, then the open, on-device CVM application returns a “Registration Failure” message to the payment application at 512 and the process 500 ends. If the appropriate authenticators are available at 516, the open, on-device CVM application may ask the authenticator to register the user at 518 and determine if the registration was successful at 520. If the registration was not successful at 520, the open, on-device CVM application returns a “Registration Failure” message to the payment application at 512 and the process 500 ends. If the registration was successful at 520, the open, on-device CVM application returns a “Registration Success” message to the payment application at 522 and the process 500 ends.

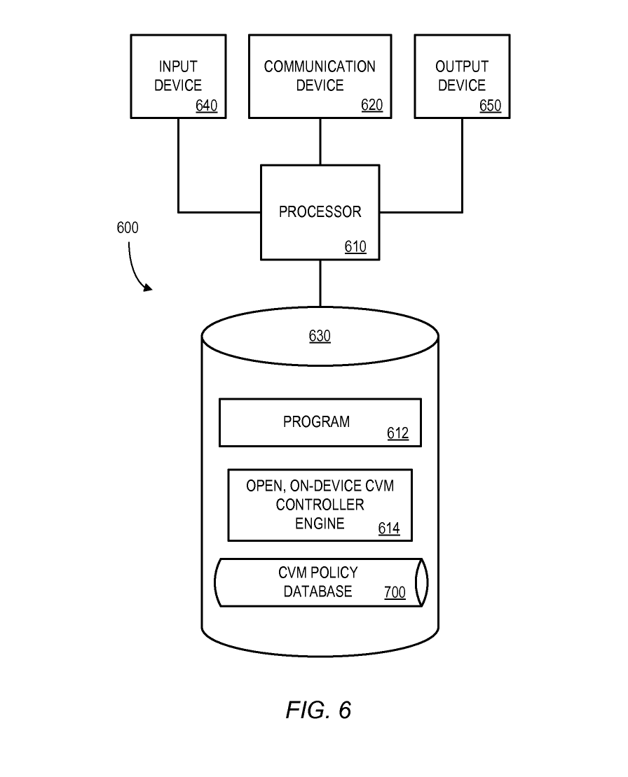

Note that the embodiments described herein may be implemented using any number of different hardware configurations. For example, FIG. 6 illustrates an open, on-device CVM controller 600 that may be, for example, associated with the systems 100, 400 of FIGS. 1 and 4. The open, on-device CVM controller 600 comprises a processor 610, such as one or more commercially available Central Processing Units (CPUs) in the form of one-chip microprocessors, coupled to a communication device 620 configured to communicate via a communication network (not shown in FIG. 6). The communication device 620 may be used to communicate, for example, with one or more remote issuer platforms and/or mobile devices. The open, on-device CVM controller 600 further includes an input device 640 (e.g., a mouse and/or keyboard to enter information about mobile devices, authenticators, issuers, etc.) and an output device 650 (e.g., to output reports).

The processor 610 also communicates with a storage device 630. The storage device 630 may comprise any appropriate information storage device, including combinations of magnetic storage devices (e.g., a hard disk drive), optical storage devices, mobile telephones, and/or semiconductor memory devices. The storage device 630 stores a program 612 and/or an open, on-device CVM controller engine 614 for controlling the processor 610. The processor 610 performs instructions of the programs 612, 614, and thereby operates in accordance with any of the embodiments described herein. For example, the processor 610 may receive CVM policies from issuer platforms and/or send CVM policies to mobile devices as appropriate.

The programs 612, 614 may be stored in a compressed, uncompiled and/or encrypted format. The programs 612, 614 may furthermore include other program elements, such as an operating system, a database management system, and/or device drivers used by the processor 610 to interface with peripheral devices.

As used herein, information may be “received” by or “transmitted” to, for example: (i) the open, on-device CVM controller 600 from another device; or (ii) a software application or module within the open, on-device CVM controller 600 from another software application, module, or any other source.

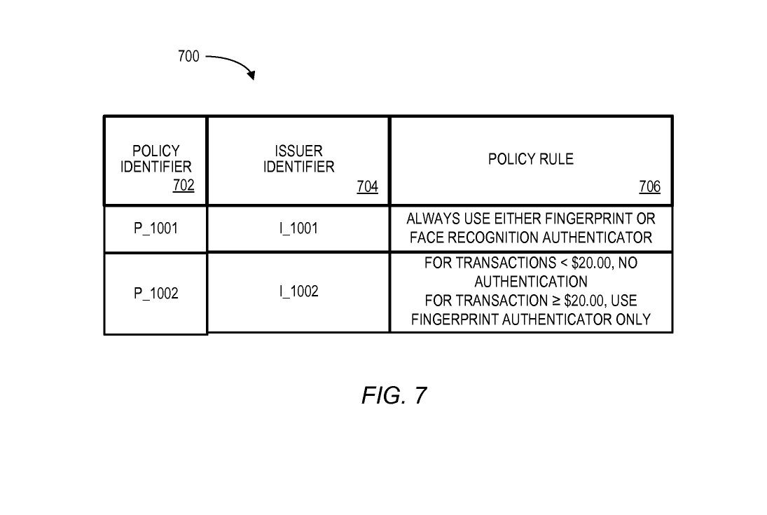

In some embodiments (such as shown in FIG. 6), the storage device 630 further stores a CVM policy database 700. An example of a database that may be used in connection with the open, on-device CVM controller 600 will now be described in detail with respect to FIG. 7. Note that the database described herein is only an example, and additional and/or different information may be stored therein. Moreover, various databases might be split or combined in accordance with any of the embodiments described herein. For example, the CVM policy database 700 and/or the other databases might be combined and stored within the open, on-device CVM controller engine 614.

Referring to FIG. 7, a table is shown that represents the CVM policy database 700 that may be stored at the open, on-device CVM controller 600 according to some embodiments. The table may include, for example, entries identifying particular CVM policies to be to be followed during transactions in accordance with some embodiments described herein. The table may also define fields 702, 704, 706 for each of the entries. The fields 702, 704, 706 may, according to some embodiments, specify: a policy identifier 702, an issuer identifier 704, and a policy rule 706. The CVM policy database 700 may be created and updated, for example, as new information is received from issuer platforms.

The policy identifier 702 may be, for example, a unique alphanumeric code identifying a CVM policy that may be applied to a transaction and the issuer identifier may indicate which issuer is associated with that CVM policy. Note that multiple issuers might be associated with a single CVM policy and/or multiple CVM policies might be associated with a single issuer. The policy rule 706 might comprise any number of rules, logic, conditions, etc. that might be applicable to a payment transaction. The policy rule 706 might, for example, require one type of CVM authentication at a gas station and a different type of CVM authentication when the cardholder travels to another country.

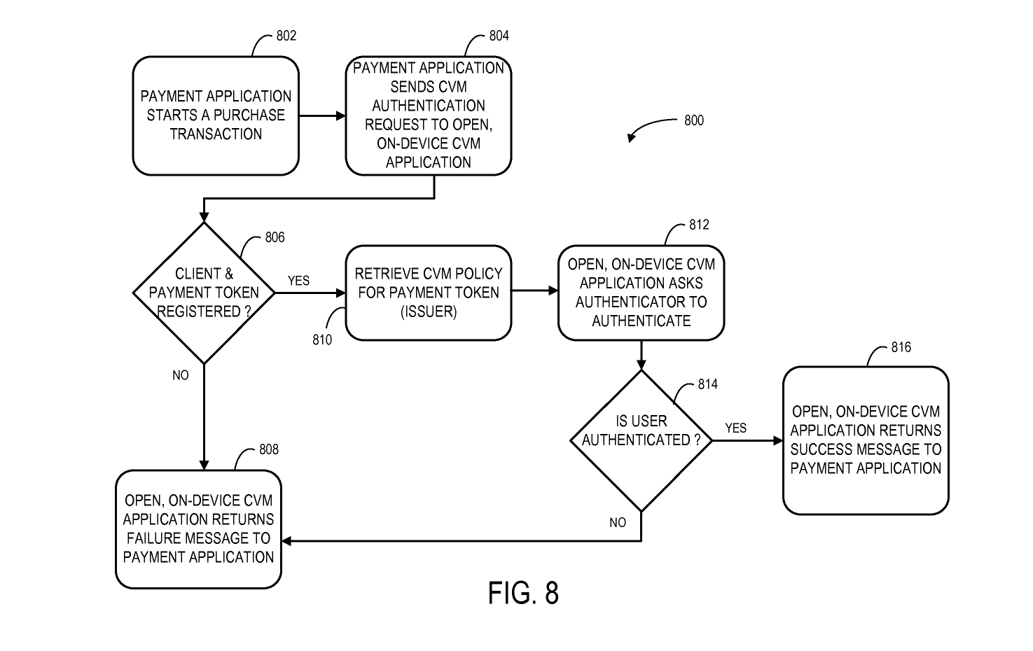

FIG. 8 is a process flow diagram illustrating an open, on-device CVM payment procedure 800 in accordance with some embodiments. Initially, at 802 a payment application starts a purchase transaction. For example, a user might indicate that he or she would like to make a purchase using a credit card account in an electronic wallet on a smartphone. At 804, the payment application sends a CVM authentication request to an open, on-device application executing at the mobile device (e.g., executing in a secure execution environment of the mobile device). If the open, on-device application does not recognize that both the client (payment application) and payment token have previously been registered at 806, a “Failure” may be returned to payment application at 808 and the process 800 ends (that is, the user's transaction will not be authorized).

If the open, on-device application recognizes that both the client (payment application) and payment token have previously been registered at 806, the appropriate CVM policy may be retrieved for the payment token (e.g., based on the issuer associated with that payment token) at 810. Moreover, the open, on-device application may ask the appropriate authenticator to authenticate the user at 812 (selected based on the retrieved CVM policy). If the user is not authenticated at 814, a “Failure” may be returned to payment application at 808 and the process 800 ends (that is, the user's transaction will not be authorized). If the user is properly authenticated at 814, a “Success” may be returned to payment application at 816 and this process 800 ends (that is, the payment application may continue with the transaction, such as by having the user perform a Near Field Communication (“NFC”) tap at a merchant device and then proceeding to determine if the issuer agrees to authorize the user's transaction).

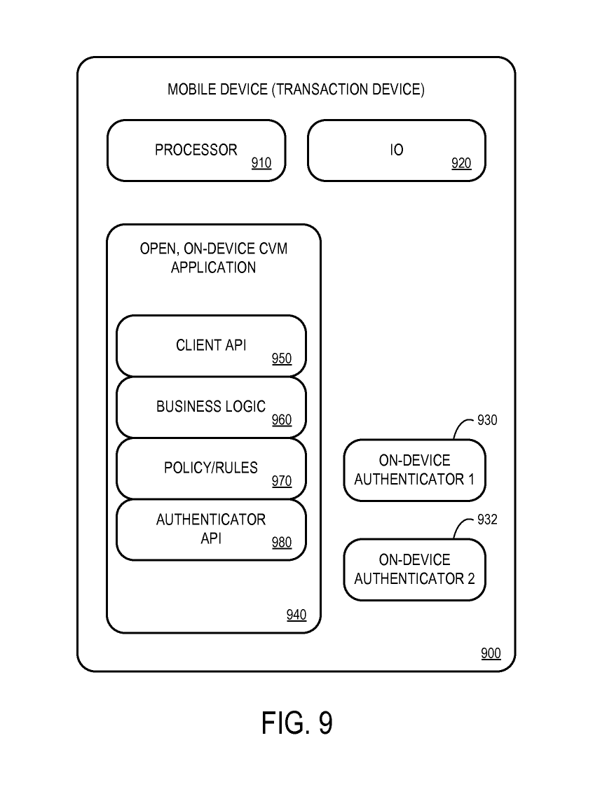

FIG. 9 is a block diagram overview of mobile device 900 in accordance with some embodiments. The mobile device 900 may include a processor and Input Output (“IO”) functionality. Note that the embodiments described herein may be implemented using any number of different hardware configurations. For example, the mobile device 900 processor 910 might include one or more commercially available CPUs in the form of one-chip microprocessors, coupled to a communication device configured to communicate via a communication network. The communication device may be used to communicate, for example, a telephone or Wi-Fi network. The IO functionality 920 may support input devices (e.g., a button or touchscreen) and output devices (e.g., speaker or display screen). The mobile device 900 may further have multiple on-device authenticators 930, 932, such as fingerprint or retinal scanners, cameras, microphones, etc.

The processor 910 may also communicates with a storage device, which may comprise any appropriate information storage device, including combinations of magnetic storage devices (e.g., a hard disk drive), optical storage devices, mobile telephones, and/or semiconductor memory devices. The storage device may store programs for controlling the processor. The processor performs instructions of the programs and thereby operates in accordance with any of the embodiments described herein. For example, an open, on-device CVM application might include client APIs 950 (to interact with payment application), business logic 960, a policy rules processing and storage component 970, and on-device APIs 980 (to interact with the authenticators 930, 932).

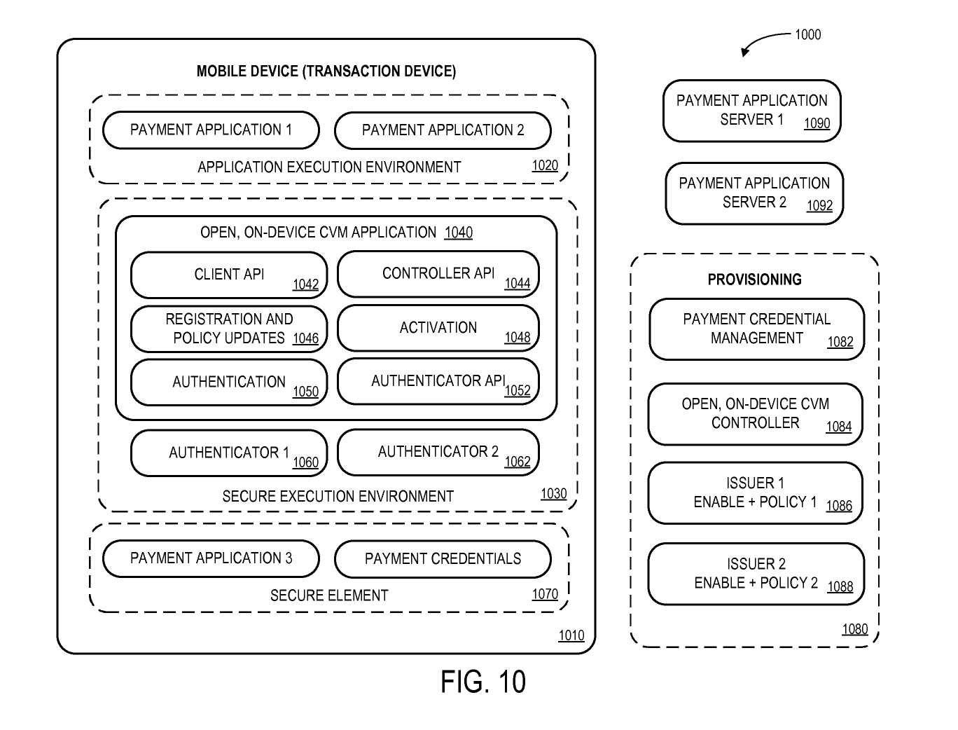

FIG. 10 illustrates an open, on-device CVM environment 1000 in accordance with some embodiments. In particular, a mobile device 1010 may include an application execution environment 1020 where one or more payment applications may execute. The mobile device 1010 may further have a secure execution environment 1030 executing an open, on-device CVM application 1040. The open, on-device CVM application 1040 may interact with the payment applications in the application execution environment 1020 via client APIs 1042. The open, on-device CVM application 1040 may further include controller APIs 1044, a registration and CVM policy update component 1046 (to match payment tokens with correct CVM polices), an activation component 1048 (e.g., to support a new activations), an authentication component 1050, and authentication APIs 1052 (to perform CVM with registered authenticators on the mobile device 1010). The secure execution environment 1030 may further include one or more authenticators 1060, 1062. If available, the mobile device 1010 may store payment applications and/or payment credentials within a secure element 1070 resistant to tampering or alteration.

Provisioning components 1080 may include payment credential management 1082, an open, on-device CVM controller 1084 (to manage issuer defined policy updates to the open, on-device CVM application 1040), and issuers 1086, 1088 (comprising, for example, an enabled program and a specific policy for the program). Finally, the payment applications in the application execution environment 1020 of the mobile device 1010 may communicate with payment application servers 1090, 1092 to have payment transactions approved.

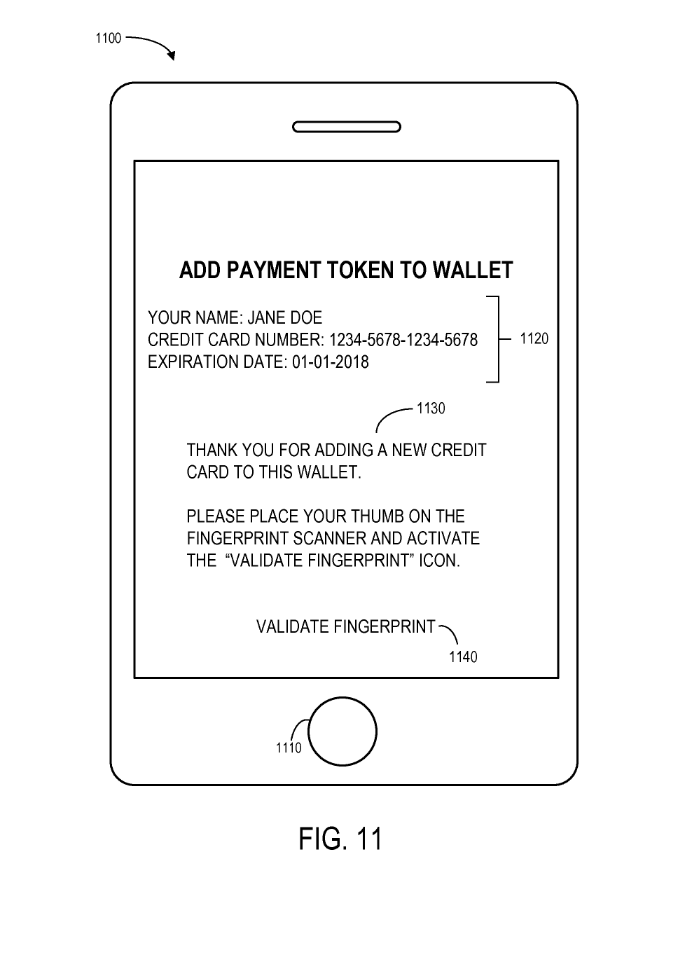

The environment 1000 of FIG. 10 may allow for a flexible implementation of CVM user authentication on mobile devices 1010. For example, FIG. 11 is an example of a mobile device 1100 display that might be provided in accordance with some embodiments. In this embodiment, the mobile device 1100 includes a fingerprint scanner 1110. The display might include payment account details 1120 along with instructions 1130 asking the user to place his or her thumb on the fingerprint scanner 1110 and to activate an icon 1140 on the display to authenticate his or her identity to complete a CVM process for the transaction. When the user is authenticated, the payment transaction with the merchant is executed. Although some embodiments have been described with respect to mobile device for Point Of Sale (“POS”) transactions, note that any of the embodiments provided herein may be associated with online purchases.

Thus, embodiments may give cardholders greater confidence that transactions are secure, which may translate into greater card usage, top-of-wallet status, and/or cardholder loyalty. Moreover, lost, stolen, and Never-Received-Issue (“NRI”) fraud losses may be reduced along with exception-processing costs (e.g., retrieving signature slips to prove that transactions occurred may not be necessary). Embodiments described herein may provide a substantially high overall level of security for an ecommerce ecosystem.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer-implemented method, comprising:
receiving, at an open, on-device Cardholder Verification Method (“CVM”) controller, CVM policies from issuer platforms;
storing the CVM policies in a CVM policy database at the open, on-device CVM controller;
receiving, at the open, on-device CVM controller, a request from a remote mobile device;
automatically determining, by a processor of the open, on-device CVM controller, at least one issuer associated with the request;
retrieving at least one CVM policy from the CVM policy database based on the determined at least one issuer; and
transmitting the retrieved CVM policy to the remote mobile device.

2. The method of claim 1, wherein the request comprises a registration request associated with a payment token for a payment application.

3. The method of claim 2, wherein the payment token is associated with at least one of: (i) a credit card, (ii) a debit card, or (iii) a pre-paid stored value card.

4. The method of claim 1, wherein at least one CVM policy is associated with at least one of: (i) a mobile device type, (ii) a mobile device authenticator type, (iii) a personal identification number, and (iv) a transaction amount.

5. The method of claim 1, further comprising:
transmitting a CVM policy update to the remote mobile device.

6. An open, on-device Cardholder Verification Method (“CVM”) controller, comprising:
a first communication port to receive CVM policies from issuer platforms;
a CVM policy database storing the CVM policies;
a second communication port to receive a request from a remote mobile device; and
a controller engine to: (i) determine at least one issuer associated with the request, (ii) retrieve at least one CVM policy from the CVM policy database based on the determined at least one issuer, and (iii) transmit the retrieved CVM policy to the remote mobile device.

7. The system of claim 6, wherein the request comprises a registration request associated with a payment token for a payment application, and the payment token is associated with at least one of: (i) a credit card, (ii) a debit card, or (iii) a pre-paid stored value card.

8. The system of claim 6, wherein at least one CVM policy is associated with at least one of: (i) a mobile device type, (ii) a mobile device authenticator type, (iii) a personal identification number, and (iv) a transaction amount.

9. A computer-implemented method, comprising:
receiving, at an open, on-device Cardholder Verification Method (“CVM”) application executing in a secure execution environment of a mobile device, a CVM authentication request from a payment application executing in an application execution environment of the mobile device, the CVM authentication request being associated with a payment token;
responsive to the authentication request, accessing a CVM policy based on the payment token;
arranging for an authenticator of the mobile device to authenticate a user of the mobile device in accordance with the CVM policy; and
when the user is authenticated, sending an authentication success indication from the open, on-device CVM application to the payment application.

10. The method of claim 9, wherein the mobile device comprises at least one of: (i) a smartphone, (ii) a tablet computer, (iii) a watch, (iv) an automobile, (v) a laptop computer, (vi) a pair of eyeglasses, and (vii) any other mobile device.

11. The method of claim 9, wherein the payment token is associated with at least one of: (i) a credit card, (ii) a debit card, or (iii) a pre-paid stored value card.

12. The method of claim 9, wherein at least one CVM policy is associated with at least one of: (i) a mobile device type, (ii) a mobile device authenticator type, (iii) a personal identification number, and (iv) a transaction amount.

13. The method of claim 9, further comprising:
determining, by the payment application, that a new payment token is to be added; and
sending a registration request from the payment application to the open, on-device CVM application.

14. The method of claim 9, further comprising:
receiving the CVM policy from a remote open, on-device CVM controller via a communication network, wherein the CVM policy is associated with a plurality of potential authenticators.

15. The method of claim 9, wherein the open, on-device CVM application includes: (i) client application programming interfaces, (ii) business logic, (iii) a policy rules processing and storage component, and (iv) on-device authenticator application programming interfaces.

16. A mobile device, comprising:
an application execution environment executing a payment application that generates a Cardholder Verification Method (“CVM”) authentication request associated with a payment token;
a plurality of authenticators; and
a secure execution environment executing a CVM application to: (i) receive the authentication request, (ii) access a CVM policy based on the payment token, (iii) arranging for at least one of authenticators to authenticate a user of the mobile device in accordance with the CVM policy, and (iv) when the user is authenticate, send an authentication success indication from the open, on-device CVM application to the payment application.

17. The mobile device of claim 16, wherein the mobile device comprises at least one of: (i) a smartphone, (ii) a tablet computer, (iii) a watch, (iv) an automobile, (v) a laptop computer, (vi) a pair of eyeglasses, and (vii) any other mobile device.

18. The mobile device of claim 16, wherein the payment token is associated with at least one of: (i) a credit card, (ii) a debit card, or (iii) a pre-paid stored value card.

19. The mobile device of claim 16, wherein at least one CVM policy is associated with at least one of: (i) a mobile device type, (ii) a mobile device authenticator type, (iii) a personal identification number, and (iv) a transaction amount.

20. The mobile device of claim 16, further comprising:
determining, by the payment application, that a new payment token is to be added; and
sending a registration request from the payment application to the open, on-device CVM application.

21. The mobile device of claim 16, further comprising:
receiving the CVM policy from a remote open, on-device CVM controller via a communication network, wherein the CVM policy is associated with a plurality of potential authenticators.

22. The mobile device of claim 16, wherein the open, on-device CVM application includes: (i) client application programming interfaces, (ii) business logic, (iii) a policy rules processing and storage component, and (iv) on-device authenticator application programming interfaces.
